(19) United States
(12) Patent Application Publication
(10) Pub. No.: US 2011/0110211 A1
(43) Pub. Date: May 12, 2011

(54) EXTERNAL COMPACT DISC DRIVE FOR DATA ENCRYPTION AND DECRYPTION AND METHOD FOR THE SAME

(76) Inventor: Chia-Che HU, Taipei (TW)

(21) Appl. No.: 12/617,524

(22) Filed: Nov. 12, 2009

(51) Int. Cl. G11B 19/04

(52) U.S. Cl. 369/53.21; G9B/19.005

(57) ABSTRACT

An external compact disc drive for data encryption and decryption and the method is disclosed. The back up data is encrypted, via an encryption key generated by an encryption/decryption unit of the external compact disc drive during the recording of back up data to a compact disc. The encrypted back up data is saved to a public area of the compact disc. An authentication key is generated via an authentication password set up by a user. The encryption key is encrypted via authentication key and saved to a private area of the compact disc. The authentication password and the authentication key are not recorded in the external compact disc drive or the compact disc. Thus, encryption key can only be retrieved with a correct authentication password via a compact disc drive having the encryption/decryption unit. Following that, the back up data can be decrypted and retrieved.

### BACKGROUND OF THE INVENTION

1. Field of the Invention

The present invention generally relates to an external compact disc drive, in particular, relates to an data recording and retrieving method using an external compact disc drive.

2. Description of Prior Art

Using flash memories as the data storage medium is becoming popular in recent years. However, there are many users prefer to save data and make data backups with a compact disc considering the cost.

When making data backups with compact discs, it remains a concerning issue that there is not a data encrypting/decrypting method dedicated to compact disc drives/compact discs. Currently, a conventional and frequently used method is encrypting back up data via an encrypting/decrypting application in a computer. Then the encrypted back up data is recorded to a recordable compact disc via a recording application and a compact disc drive with recording function. During retrieving the encrypted back up data, the encrypted back up data recorded in the compact disc is duplicated to the computer, and the encrypted back up data is decrypted via the encrypting/decrypting application to generate the back up data.

Admittedly, the above mentioned encrypting/decrypting process is relatively simple yet the operating steps are complicated which may include: 1. process back up data, 2. encrypt the back up data with an encrypting/decrypting application, 3. record encrypted back up data via a recording application recording. When a user needs to access to the encrypted back up data on the disc, the user is required to use the encrypting/decrypting application to decrypt encrypted data in the compact disc. As such, the above method is not applicable to the scenarios when users are in a rush to make data backups or retrieve data from the back up data and do not want to go through complicated data encrypting/decrypting process.

Further, the above mentioned encrypting/decrypting method is implemented by installing an encrypting/decrypting application in a computer used for encrypting back up data before recording a data backup to a disc, as well as in all computers used for retrieving the back up data in the disc. The back up data is decrypted via the encrypting/decrypting application. The installing effort is in convenient to users and potentially a waste of space and system resource of the computers.

### SUMMARY OF THE INVENTION

The objective of the invention is to provide an external compact disc drive for data encryption and decryption. After back up data is encrypted and recorded to a compact disc, the encrypted back up data can only be retrieved via an external compact disc drive having encryption/decryption unit.

The other objective of the invention is to provide a method for data encryption and decryption applicable to an external compact disc drive. After back up data is encrypted and recorded to a compact disc, the encrypted back up data can only be retrieved via decrypting the encrypted back up data with a correct authentication password.

In order to realize the above goal, device and method of the present invention first encrypt back up data via an encryption key generated by an encryption/decryption unit of the external compact disc drive during the recording of back up data to a compact disc. The encrypted back up data is saved to a public area of the compact disc. An authentication key is generated via an authentication password set up by a user. The encryption key is encrypted via authentication key and saved to a private area of the compact disc. The authentication password and the authentication key are not recorded in the external compact disc drive or the compact disc.

Compare to prior are, the advantages of the present invention are that it is more convenient to users to retrieve and decrypt encrypted back up data at a high security level by an external compact disc drive without installing corresponding encrypting/decrypting applications in computers used for retrieving back up data. In addition, users set up an authentication password to provide further protection on data. The authentication password is not recorded in the external compact disc drive or the compact disc to assure that only persons given the authentication password is permitted to retrieve and encrypt the back up data.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 illustrates a connection schematic diagram of a compact disc drive according to a preferred embodiment of the presenting invention;

FIG. 2 illustrates a block diagram of a preferred embodiment of the presenting invention;

FIG. 3 illustrates a data schematic diagram of a preferred embodiment of the presenting invention;

FIG. 4 illustrates a recording flow chart of a preferred embodiment of the presenting invention; and

FIG. 5 illustrates of a data retrieving flow chart of a preferred embodiment of the presenting invention.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

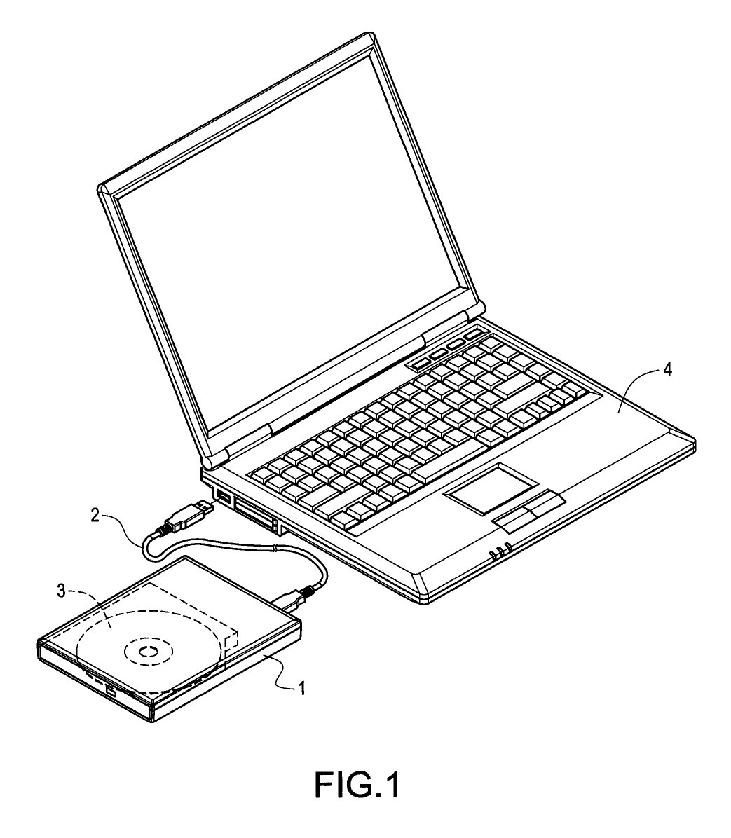

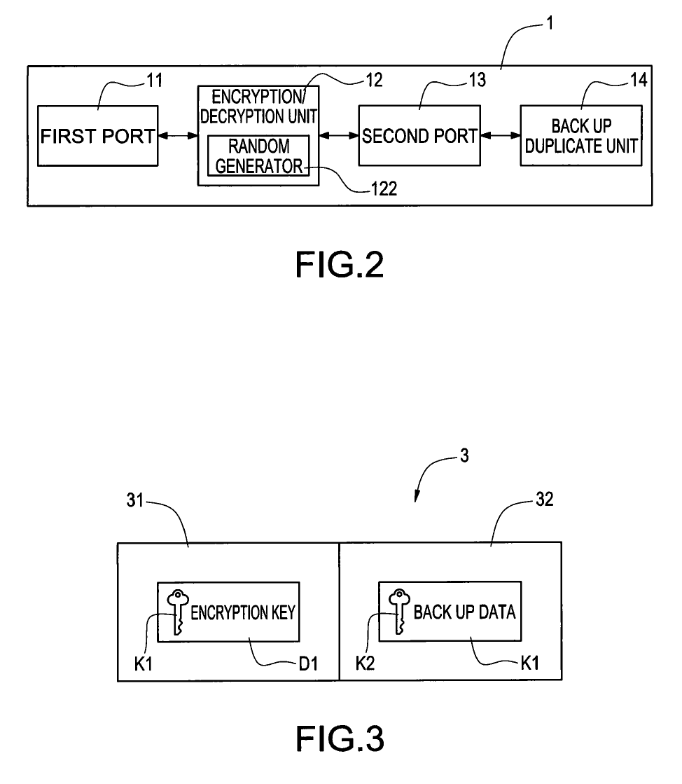

FIG. 1 illustrates a connection schematic diagram of a compact disc drive according to a preferred embodiment of the presenting invention. As shown in the diagram, the external compact disc drive 1 of present invention is used for recording data to a compact disc 3, or retrieving data from the compact disc. The external compact disc drive 1 is compatible with a compact disc 3 such as a CD-ROM, a CD-RW, a DVD+R, a DVD-R, or a Blue-Ray Disc (BD), but the implementation of the invention is not limited to the above. The external compact disc drive 1 receives back up data from an external computer 4 via a connect cable 2, processes the back up data and records the back up data to the compact disc 3. The connect cable 2 utilizes interface protocols such as Universal Serial Bus (USB), External Serial Advanced Technology Attachment (eSATA), or FireWire IEEE 1394, depending on the port equipped on the external compact disc drive 1 (refer to FIG. 2), but not limited to the above interface protocols only.

FIG. 2 illustrates a block diagram of a preferred embodiment of the presenting invention. As shown in the diagram, the external compact disc drive 1 comprises a first port 11, an encryption/decryption unit 12, a second port 13, and a back up duplicate unit 14. The first port 11 can be a USB port, an eSATA port, or an IEEE 1394 port corresponding to the protocol used by the connect cable 2. The second port 13 utilizes interface protocols such as Serial Advanced Technology Attachment (SATA) or Integrated Device Electronics (IDE). The back up duplicate unit 14 is a compact disc recording device for accommodating the compact disc 3 and performing data recording or retrieving. The transmission interface used by the back up duplicate unit 14 corresponds to the transmission interface used by the second port 13, yet the protocols used by a transmission interface is not limited to the above according to the present invention.

The back up data in the external computer 4 (refer to D1 in FIG. 3) is transferred to a data register in the external compact disc drive 1 (not shown in the diagram) via the first port 11 during data recording. The encryption/decryption unit 12 generates a random encryption key (refer to K1 in FIG. 3) used for encrypting the back up data D1. Subsequently, the encrypted back up data D1 is transferred to the back up duplicate unit 14 via the second port 13 and is recorded to the compact disc 3. The encryption/decryption unit 12 further comprises a random generator 122 for generating the encryption key K1 with the random generator 122. The encryption key K1 utilizes Advanced Encryption Standard (AES), but the scope of the present invention is not limited to the above. It should be noted that given it is known that the encryption key K1 is generated by the random generator 122. However, the random generator 122 random generates the encryption key K1 without a fix referencing mechanism. The encryption key K1 is confidential even to users and developers of the external compact disc drive 1, which assure the security standards of the method the encrypting back up data D1 according to the present invention is kept at a high level.

FIG. 3 illustrates a data schematic diagram of a preferred embodiment of the presenting invention. The internal space of the compact disc 3 recorded by the external compact disc drive 1 of the invention is allocated into two parts: a public area 31 and a private area 32. During data recording, the encrypted back up data D1 is saved in the public area 31 and the encryption key K1 is saved in the private area 32. All data saved in the public area 31 is encrypted via the encryption key K1 and all data saved in the private area 32 including the encryption key K1 is encrypted via an authentication key K2 so as to provide protection on the data from unauthorized access. The authentication key K2 is generated via the random generator 122 of the encryption/decryption unit 12 according to an input parameter. If an authentication password is setup by a user, the encryption/decryption unit 12 uses a predetermined default password as the input parameter to trigger the random generator 122 to generate the authentication key K2 during data recording. If an authentication password is setup by a user, the encryption/decryption unit 12 uses the authentication password as the input parameter to trigger the random generator 122 to generate the authentication key K2 during data recording. It should be noted that the generated authentication key K2 is not recorded in the external compact disc drive 1 or the compact disc 3. Instead, the authentication key K2 is generated each time by the encryption/decryption unit 12 triggering the random generator 122 according to an input parameter (an authentication password or a predetermined default password).

The length of the above mentioned authentication password is 128 bit or 256 bit configurable by users. When an external compact disc drive is connected to the external computer 4 ready to make (retrieve) a data backup, an installation free green software offered by the developer is executed to display a password dialogue box (not shown in the diagram). The user inputs the authentication password of corresponding length via input interface such as texts, numbers, or combinations mixed with texts and numbers, but the scope of the invention is not limited to the above only.

The external compact disc drive 1 of the invention allocates compact disc 3 into the public area 31 and the private area 32 during data recording. Such recording step does not require a special compact disc. It is applicable to all compact discs. Though, the compact disc 3 recorded by the external compact disc drive 1 is only retrievable by the external compact disc drive 1. The following details the recording and retrieving procedure steps of the external compact disc drive 1 with reference to a flow chart.

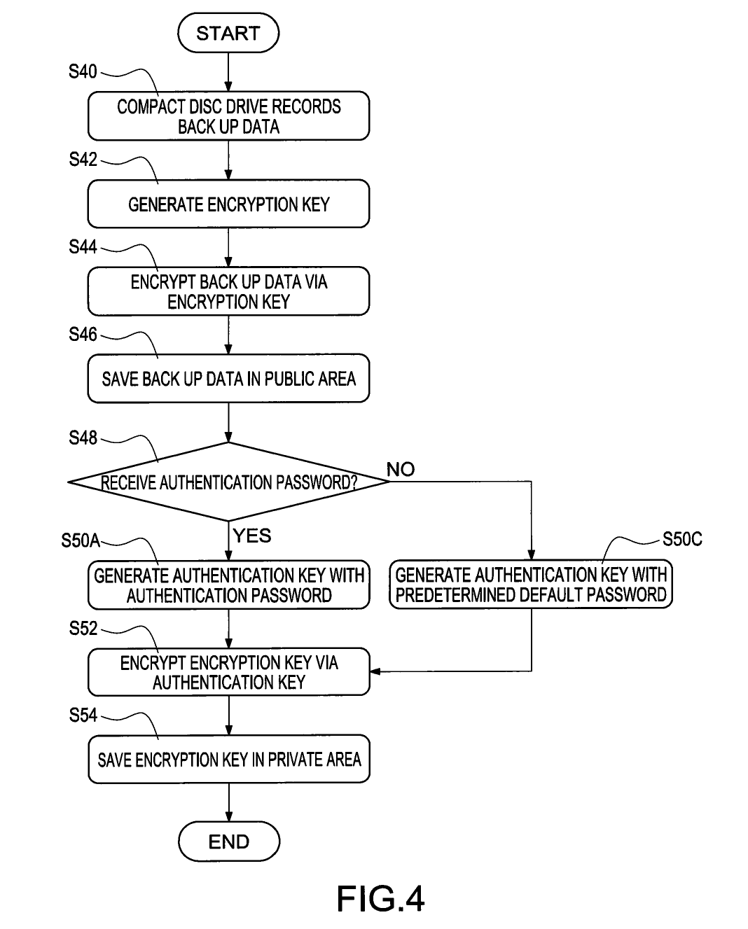

FIG. 4 illustrates a recording flow chart of a preferred embodiment of the presenting invention. First, an external compact disc drive 1 is connected to an external computer 4. The external compact disc drive 1 records back up data D1 (step S40). When the external compact disc drive 1 is used for the first time, an encryption/decryption unit 12 of the external compact disc drive 1 generates an encryption key K1 via a random generator 122 (step S42). Subsequently, the external compact disc drive 1 receives the back up data D1 of the external computer 4 saved in the data register of the external compact disc drive, the encryption/decryption unit 12 encrypts the back up data D1 via the encryption key K1 during data recording (step S44). As encryption of the back up data D1 completes, the encrypted back up data D1 is saved to the public area 31 of an compact disc 3 (step S46). Subsequently, the encryption/decryption unit 12 determines if an authentication password input by the user is received from the external computer 4 (step S48). If yes, the random generator 122 is triggered by the authentication password to generate the authentication key K2 (step S50A). If not, the random generator 122 is triggered by a predetermined default password in the external compact disc drive to generate the authentication key K2 (step S50C).

None the less, under the circumstance that the user does not setup the authentication password and the encryption/decryption unit 12 generates the authentication key K2 with the predetermined default password, yet the user desire to re-setup the authentication password, the encryption/decryption unit 12 uses the most recent authentication password input by the user to replace the predetermined default password for triggering the random generator 122 to re-generate the authentication key K2. Typically, the user is required to input the authentication password to decrypt and access the back up data D1 in the following retrieving step. When the user uses predetermined default password for generating the authentication key K2, the user is not required to input any password in the following retrieving step.

Lastly, the authentication key K2 is generated and used for encrypting the encryption key K1 via the encryption/decryption unit 12 (step S52), and the encrypted encryption key K1 is saved in the private area 32 of the compact disc 3 (step S54). As such, the encryption key K1 can not access easily by multiple protection of encrypting via the authentication key K2 and saving in the private area 32.

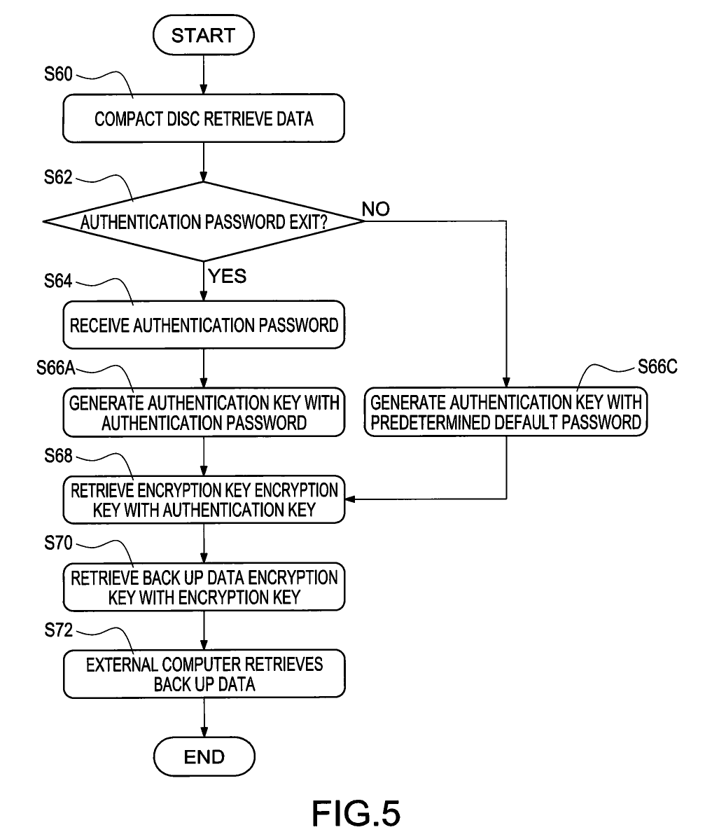

FIG. 5 illustrates of a data retrieving flow chart of a preferred embodiment of the presenting invention. The external compact disc drive 1 is connected to the external computer 4. The external computer 4 retrieves data from the external compact disc drive 1 (step S60). The data retrieved is saved in the compact disc 3 of the external compact disc drive 1. Subsequently, the encryption/decryption unit 12 of the external compact disc drive 1 determines if the authentication password setup by the user during data recording is on the compact disc 3 (step S62). If yes, the external compact disc drive 1 waits to receive the authentication password from the external computer 4 input by the user (step S64). The external compact disc drive 1 triggers the random generator 122 to generate the authentication key K2 via the received authentication password (step S66A). If the decision of step S62 is no, the encryption/decryption unit 12 triggers the random generator 122 to generate the authentication key K2 via the predetermined default password (step S66C). Following the authentication key K2 is generated in the above steps, the encryption/decryption unit 12 retrieves the encryption key K1 in the private area 32 of the compact disc 3 to decrypt the encryption key K1 with the authentication key K2 (step S68). Subsequently, the encryption/decryption unit 12 retrieves the back up data D1 in the public area 31 of the compact disc 3 and decrypts the back up data D1 with the decrypted encryption key K1 (step S70). Lastly, use is allowed to access the back up data D1 in the external computer 4.

As the skilled person will appreciate, various changes and modifications can be made to the described embodiments. It is intended to include all such variations, modifications and equivalents which fall within the scope of the invention, as defined in the accompanying claims

What is claimed is:

1. An external compact disc drive for data encryption and decryption, receiving back up data from an external computer, encrypting the back up data, saving the back up data to a compact disc, decrypting the encrypted back up data, retrieving the back up data, and transferring the back up data to the external computer, the compact disc read only memory comprising:
a first port electrically connected to the external computer via a corresponding connect cable;
an encryption/decryption unit electrically connected to the first port for generating an encryption key and an authentication key, encrypting the received back up data via the encryption key, and encrypting the encryption key via the authentication key;
a second port electrically connected to the encryption/decryption unit; and
a back up duplicate unit electrically connected to the second port and having a transmission interface corresponding to the second port, receiving the encrypted back up data and the encryption key, and saving the encrypted back up data and the encryption key to the compact disc;
wherein, the encryption/decryption unit repetitively generating the authentication key via decrypting the encryption key when retrieving the data, decrypting the back up data via the encryption key, and transferring the back up data from the compact disc to the external computer.

2. The external compact disc drive of claim 1, wherein the encryption/decryption unit allocates a public area and a private area on the compact disc during compact disc recording, saves the back up data in the public area, and saves the encryption key in the private area.

3. The external compact disc drive of claim 1, wherein the encryption/decryption unit further comprises a random generator for generating the encryption key and the authentication key.

4. The external compact disc drive of claim 1, wherein the first port is a universal serial bus port, an external serial advanced technology attachment port, or a firewire IEEE 1394 port.

5. The external compact disc drive of claim 1, wherein the second port is a serial advanced technology attachment port or an integrated device electronics port.

6. The external compact disc drive of claim 1, wherein the back up duplicate unit is a compact disc-recordable recorder, compact disc-rewritable recorder, digital versatile disc+recordable (DVD+R) recorder, digital versatile-disc recordable (DVD-R) recorder, or blue-ray disc recorder.

7. A data encrypting/decrypting method for an external compact disc drive, encrypting a back up data via an encryption/decryption unit of the external compact disc drive during compact disc recording, saving the encrypted back up data to a compact disc, decrypting the encrypted back up data via the encryption/decryption unit, retrieving the decrypted back up data and transferring the decrypted back up data to an external computer, the method comprising:
a) receiving the back up data the external computer during compact disc recording;
b) generating an encryption key and an authentication key by the encryption/decryption unit;
c) encrypting the back up data via the encryption key;
d) encrypting the encryption key via the authentication key;
e) saving the encrypted back up data and the encryption key to the compact disc;
f) receiving retrieving instruction from an external computer during retrieving;
g) generating the authentication key by the encryption/decryption unit following step f;
h) retrieving the encryption key from the compact disc, decrypting the encryption key via the authentication key following step g;
i) retrieving the back up data from the compact disc, and decrypting the back up data via the decrypted encryption key following step h; and
j) transferring the decrypted back up data to the external computer following step i.

8. The data encrypting/decrypting method for an external compact disc drive of claim 7, wherein the encryption key is generated by the encryption/decryption unit via a random generator in step b.

9. The data encrypting/decrypting method for an external compact disc drive of claim 8, wherein □ the method further comprises a step b0: determining if an authentication password from the external computer is received by the encryption/decryption unit prior to the step b.

10. The data encrypting/decrypting method for an external compact disc drive of claim 9, wherein if the determining result in step b0 is yes, the random generator is triggered via the authentication password to generate the authentication key in step b, the determining result in step b0 is no, the random generator is triggered via a predetermined default password to generate the authentication key in the step b.

11. The data encrypting/decrypting method for an external compact disc drive of claim 10, wherein the method further comprises a step g0: determining if the authentication password to generate the authentication key is received in the compact disc during compact disc recording by the encryption/decryption unit prior to step g.

12. The data encrypting/decrypting method for an external compact disc drive of claim 11, wherein if the determining result in step g0 is yes, the authentication password is received to trigger the random generator to generate the authentication key in the step g, and if the determining result in step g0 is no, the random generator is triggered via a predetermined default password to generate the authentication key in step g.

13. The data encrypting/decrypting method for an external compact disc drive of claim 10, wherein the authentication password is a 128 bit 256 bit password.

14. The data encrypting/decrypting method for an external compact disc drive of claim 10, wherein the external compact disc drive does not the authentication password and the authentication key are not saved in the external compact disc drive and the compact disc.

15. The data encrypting/decrypting method for an external compact disc drive of claim 7, wherein the back up data is saved in a public area of the compact disc and the encryption key is saved in a private area of the compact disc in the step e, and the encryption/decryption unit allocates the public area and the private area during compact disc recording.

16. The data encrypting/decrypting method for an external compact disc drive of claim 15, wherein data saved in the public area of the compact disc is encrypted via the encryption key and data saved in the private area of the compact disc is encrypted via the authentication key.

17. The data encrypting/decrypting method for an external compact disc drive of claim 7, wherein the encryption key utilizes advanced encryption standard (AES).
